(19) United States
(12) Patent Application Publication
(10) Pub. No.: US 2013/0168111 A1
(43) Pub. Date: Jul. 4, 2013

(54) FUEL TANK FLAMMABILITY-REDUCING GAS DISTRIBUTION ARCHITECTURE

(71) Applicants: Kenneth K. Wong, Irvine, CA (US); Stephen C. Metrulas, Irvine, CA (US)

(72) Inventors: Kenneth K. Wong, Irvine, CA (US); Stephen C. Metrulas, Irvine, CA (US)

(73) Assignee: PARKER-HANNIFIN CORPORATION, Cleveland, OH (US)

(21) Appl. No.: 13/819,741

(22) PCT Filed: Oct. 12, 2011
(86) PCT No.: PCT/US11/55903

§ 371 Date: Feb. 28, 2013

Related U.S. Application Data
(60) Provisional application No. 61/392,055, filed on Oct. 12, 2010.

(51) Int. Cl. A62C 2/04

(52) U.S. Cl. CPC A62C 2/04
USPC 169/62

(57) ABSTRACT

A flammability-reducing gas distribution system (10) for an aircraft includes a conduit (20) for distributing flammability-reducing gas within the fuel tank (12) while preventing or minimizing the potential for the buildup of a column of liquid against a separating valve (24) that prevents the exit of liquid fuel from the fuel tank (12). The conduit (20) includes a trap (26) in which liquid that enters the conduit (20) will accumulate. The trap (26) includes a drain (30), such as a float drain valve, to drain liquid from the trap (26) back into the fuel tank (12). The trap (26) includes a section of the conduit (20) at a local minimum elevation between sections of conduit (20) with relatively higher elevations. Consequently, any liquid that enters the distribution conduit (20) can be captured in the trap (26), minimizing or eliminating the opportunity for a liquid column to form against the separating valve (24).

### RELATED APPLICATIONS

This application claims the benefit of U.S. Provisional Application No. 61/392,055 filed Oct. 12, 2010, which is hereby incorporated herein by reference.

### FIELD OF THE INVENTION

This invention relates to a fuel tank flammability reduction system for an aircraft, and more particularly, to the flammability-reducing gas distribution architecture for an aircraft fuel tank flammability reduction system.

### BACKGROUND OF THE INVENTION

Aircraft fuel tanks are designed to accommodate a highly flammable liquid fuel. The empty space in the fuel tanks that is not filled with fuel typically has a mixture of air and fuel vapor, and is referred to as ullage. To protect against fuel tank explosions, particularly in commercial and military aircraft, a potentially explosive mixture of fuel vapor and air above the fuel in the ullage space of the tanks often is replaced or diluted with a flammability-reducing gas, such as nitrogen-enriched air (NEA), which also can be referred to as an inerting gas since it is used to reduce the oxygen content to render the ullage gas inert. The NEA or other flammability-reducing gas is distributed to the ullage space in each fuel tank to reduce the concentration of oxygen to an inert level, or to reduce the temperature of the fuel below its lower flammability limit temperature, thereby rendering the fuel tank ullage non-flammable as defined by the U.S. Federal Aviation Administration for commercial aircraft. The flammability-reducing gas may also be used to render the fuel vapor-to-air ratio of the ullage to be too lean for combustion, by reducing the fuel-air ratio to near zero.

Most fuel tank flammability reduction systems use compressed air bled from the engines and condition the compressed air to generate flammability-reducing gas. The flammability-reducing gas is delivered to various fuel tank compartments via a distribution network of tubing and outlets. The main conduit of the flammability-reducing gas distribution network may be forced to penetrate the front or rear spar of the center fuel tank at a point that is below the liquid fuel surface when the tank is full of fuel, due to structural or space constraints.

When the fuel tank flammability reduction system is operating, the flammability-reducing gas flows into the tank and generally prevents fuel from flowing back upstream in the flammability-reducing gas distribution network. In addition, the network typically includes a separating valve to prevent fuel backflow outside the fuel tank. When the fuel tank flammability reduction system is inoperative and the aircraft is operating, however, there is no gas flow and thus no pressure inside the distribution network. Fuel can enter the network of tubing due to aircraft maneuvering and gravity. If the valves in the network leak, fuel can migrate outside the fuel tank, towards a hot compressed air source, for example, which could create potential safety hazards.

U.S. Pat. No. 7,152,635 describes one such fuel tank flammability reduction system for commercial aircraft. In this system, the flammability-reducing gas passes through a fuel tank check valve and then a float valve before mixing with the ullage in the fuel tank. The float valve is attached at the end of a duct and is intended to provide unobstructed flow at the point where the flammability-reducing gas flows into the fuel tank. Such float valves typically have a large lever arm with a buoyant volume attached. The buoyancy lifts the lever arm about a hinge and seats a capping device onto the end of the duct to prevent fuel from entering the duct.

### SUMMARY OF THE INVENTION

This invention provides several features besides the separating valves embodied in prior flammability-reducing gas distribution networks by which the probability of the above-mentioned fuel back-flow safety hazards can be significantly reduced or eliminated.

While the flammability reduction system is intended to distribute a flammability-reducing gas into the ullage space to maintain a low-oxygen environment, under some conditions liquid, typically fuel, can enter the conduit used to distribute the flammability-reducing gas in the fuel tank. Previous systems attempted to prevent liquid from entering the conduit in the first place, generally by using float valves, but those methods have not always been successful. In attempting to keep the fuel out of the distribution network, previous systems generally made no provisions for evacuating any fuel that might nevertheless enter the conduit. In some systems, a column of liquid was able to accumulate in the distribution conduit downstream of the separating valve. The pressure applied by this column of liquid can cause this separating valve to leak. Then, fuel can flow outside the fuel tank down towards the supply of flammability-reducing gas outside the fuel tank, which often contains ignition sources that may ignite the fuel.

The present invention provides a fuel tank flammability reduction gas distribution system for an aircraft that provides a way to distribute flammability-reducing gas within the fuel tank while preventing or minimizing the potential for liquid fuel to rest against the separating valve, while also providing a way to clear liquid from the distribution conduit. Specifically, the present invention provides a conduit for distributing flammability-reducing gas that includes a trap in which liquids can accumulate, and may also contain a float drain valve. An exemplary trap is located at a local minimum elevation between sections of conduit with a relatively higher elevation, with a float drain valve typically, but not necessarily, connected to the trapping conduit or reservoir at the local minimum elevation to help drain accumulated liquid from the trap.

Further features of the invention will become apparent from the following detailed description when considered in conjunction with the drawings.

### BRIEF DESCRIPTION OF THE DRAWINGS

FIG. 1 is a schematic plan view of one embodiment of an aircraft inerting system according to the invention.

FIG. 2 is a schematic elevation view of the system of FIG. 1 as seen along section 2-2 of FIG. 1.

FIG. 3 is an alternative schematic elevation view of the system of FIG. 1 as seen along section 2-2 of FIG. 1.

FIG. 4 is an enlarged schematic view of section 4-4 of FIG. 3.

FIG. 5 is a schematic elevation view of an alternative embodiment of an aircraft inerting system provided by the invention.

### DETAILED DESCRIPTION

Briefly, the present invention provides a fuel tank flammability reduction gas distribution system (FTFRGDS) for an aircraft. The system includes a conduit to distribute flammability-reducing gas within a fuel tank while preventing or minimizing the potential for the buildup of a column of liquid against a separating valve that controls the entry of the flammability-reducing gas into the fuel tank. The present invention also provides a way to clear liquid from the distribution conduit. Specifically, the conduit includes a trap, which accumulates liquids that have entered the distribution system. The trap is formed by a section of conduit or a reservoir or sump at a local minimum elevation between sections of conduit with relatively higher elevations. The trap also may include a drain, such as a float drain valve, to drain liquid from the trap back into the fuel tank. Consequently, any liquid that enters the distribution conduit is captured at the trap, minimizing or eliminating the opportunity for a liquid column to form against the separating valve, thereby minimizing the opportunity for liquid to leak through the separating valve.

As in previous flammability reduction systems, in an exemplary system provided by the invention flammability-reducing gas passes through a separating valve before entering the fuel tank. This separating valve is generally located at the boundary of the fuel tank where the flammability-reducing gas distribution conduit penetrates the fuel tank.

From the penetration point inside the fuel tank, the main conduit extends downward into the trap. From the trap the conduit then extends upward and continues to nearly the highest point in the tank. The conduit may then take a U-turn downward before continuing to extend to locations where flammability reduction gas distribution outlets are placed. This duct design may be referred to as a gooseneck. The level of fuel inside the tank must therefore rise above the maximum gooseneck elevation before fuel can pass the gooseneck and accumulate in the trap.

The float drain valve connected to the trap allows any fuel trapped in the conduit or in the reservoir to drain back into the fuel tank, thereby preventing fuel from accumulating on the separating valve outlet. This reduces or eliminates the probability of fuel leaking out of the fuel tank through the separating valve. Therefore, the separating valve, the gooseneck design, the J-trap or reservoir, and the float drain valve can prevent fuel backflow from the fuel tank into the fuel tank flammability reduction system outside of the fuel tank.

In the case of a float drain valve, whether connected to a J-trap or a reservoir, the float drain valve would be closed when the fuel level is higher than the valve inlet, preventing fuel from entering the valve. When fuel accumulates downstream of the separating valve, and the fuel level is low, the float drain valve opens to drain the trapped fuel back to the tank.

The fuel tank flammability-reducing gas distribution system provided by the invention is fluidicly coupled to a flammability-reducing gas supply, which supplies a flammability-reducing gas, such as nitrogen-enriched air (NEA), to the fuel tank or tanks of the aircraft, and thus will chiefly be described in this context. The underlying principles of the invention have applicability to other aircraft and non-aircraft applications where a need exists for a supply of flammability-reducing gas and minimizing or preventing liquid columns from forming against a separating valve controlling entry of the flammability-reducing gas to the conditioned space.

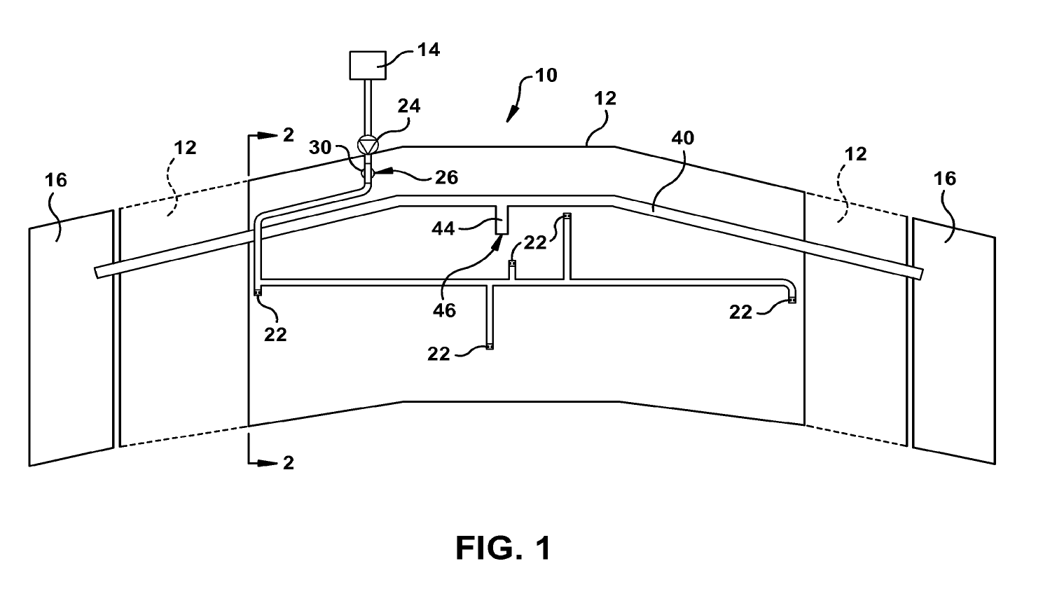

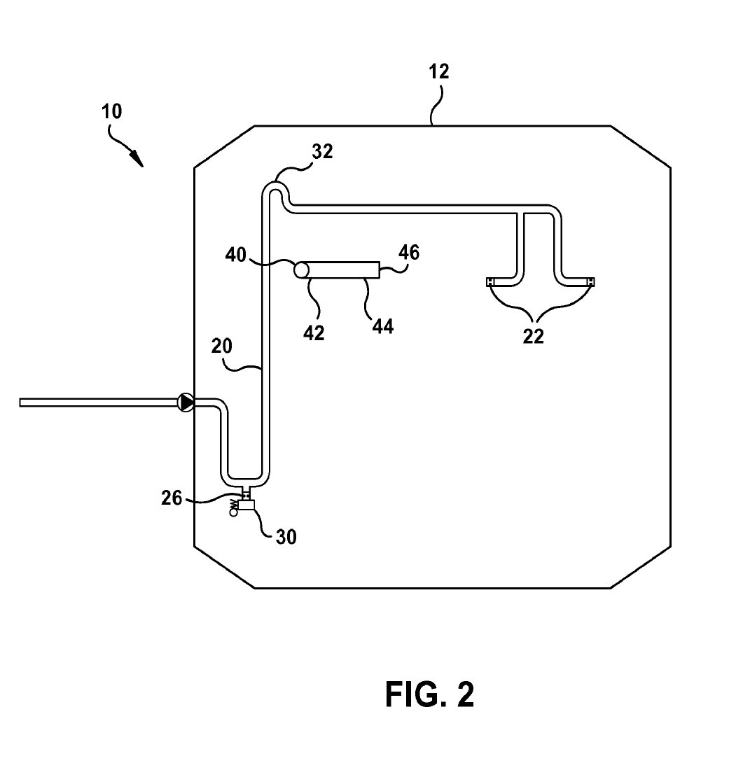

Referring now in detail to the drawings, and initially FIGS. 1 and 2, an exemplary fuel tank flammability-reducing gas distribution system (FTFRGDS) provided by the invention is indicated generally by reference numeral 10. The aircraft includes one or more fuel tanks 12, and a supply 14 of flammability-reducing gas, to mix with or replace the ullage in the fuel tanks 12 to create or maintain a non-flammable condition that inhibits or prevents ignition of the fuel in the fuel tank 12.

One or more additional fuel tanks may also be part of the aircraft design. Surge tanks 16, or overflow tanks that prevent or minimize the unwanted ejection of fuel from the aircraft, are located near the tips of the wings. The surge tanks 16 typically also include means (not shown) for draining fuel from the surge tank 16 back to the fuel tank 12.

The flammability-reducing gas distribution system 10 is coupled to the flammability-reducing gas supply 14, and includes means for delivering flammability-reducing gas, such as through a distribution network, and other means for delivery or transferring the flammability-reducing gas from the supply 14 to the fuel tanks 12. The distribution network generally includes an arrangement of conduit or pipes or other tubing 20 from the flammability-reducing gas supply 14 to and within each fuel tank 12. The flammability-reducing gas distribution conduit 20 typically penetrates the fuel tank 12 at a relatively high location in the tank 12, and if practical, in an area that is rarely wetted with liquid fuel. To correctly apportion the flow between multiple tanks, fixed flow control orifices may be installed at the distribution network outlets 22. With orifices, these outlets 22 apply a small back pressure in the conduit 16, thereby affecting the flow of flammability-reducing gas into each tank 12. If orifices are installed at the outlets 22, the orifices are sized to optimally apportion the available flow to each tank 12.

The flammability-reducing gas distribution system preferably prevents or minimizes passage of fluid, particularly liquid fuel and fuel vapor, from the fuel tank 12 to the flammability reduction gas supply 14. To that end, the conduit 20 includes a “check” or “non-return” valve 24 or other means for isolating or separating the flammability-reducing gas supply 14 from the contents of the fuel tank 12. The check valve 24 typically is mounted to a boundary of the fuel tank 12. The check valve 24 thus protects the flammability-reducing gas supply 14 from backflow of fluid, such as water or fuel or fuel vapor, thereby separating fuel and fuel vapor from potential ignition sources in the flammability-reducing gas supply 14. Leakage of liquid fuel can occur across check valves, especially if a column of fuel is allowed to rest on the check valve. Leakage may also occur across the check valve if the valve is forced open due to vibration or acceleration loads of the aircraft.

Consequently, near the location where the distribution conduit 20 enters the fuel tank 12, a section of the conduit branches off to a trap 26. The trap 26 is located at a local relative minimum elevation in the conduit 20, where a section of the conduit 20 between the check valve 24 and the trap 26 is higher, and a section of the conduit 20 downstream of the trap 26 also is higher. The trap 26 is thus formed of a J-shaped section of conduit, and can be referred to as a J-trap. From the trap, the downstream section of conduit defines a local high point 32 between the trap 26 and the outlets 22. This arrangement reduces the flow of liquid that may enter the trap 26 through the conduit 20, and results in nearly zero probability that liquid may migrate from the fuel tank 12, through the outlet 22, over the gooseneck 32, and past the trap 26 to rest against the check valve 24.

The trap 26 may also include means to drain the liquid from the distribution conduit 20. In an exemplary embodiment, the drain means includes a float drain valve 30. The float drain valve 30 is mounted in the conduit 20 at the low point of the trap 26. The float drain valve 30 is mounted at an elevation lower than both the check valve 24 and the local high point 32, near the conduit's penetration point into the fuel tank 12.

A float drain valve 30 typically includes a buoyant element that blocks passage of fluid through the valve 30 into the conduit 20, so the pressure of the supplied flammability-reducing gas or liquid column in the conduit 20 cannot overcome the upward pressure of the liquid fuel in the tank 12, when the fuel level is higher than the elevation of the drain valve 30. In this case the drain valve 30 will close and prevent fuel from entering the conduit 20 through the drain valve 30. When the liquid level in the fuel tank 12 falls below the elevation of the drain valve, the buoyant element will unseat, allowing trapped liquid to drain from the conduit 20 through the drain valve 30 and back into the fuel tank 12.

When the flammability-reducing gas is being supplied and the fuel level is low, the float drain valve 30 will be open, allowing the flammability-reducing gas to enter the tank 12 through the drain valve 30. To control the rate of gas flow through the drain valve 30, an orifice may be employed upstream or as part of the drain valve 30. When flammability-reducing gas is being supplied, the flowing gas will act on the free surface of the liquid to force the liquid in the conduit back toward the discharge outlets 22. Often this is sufficient to clear the conduit. When flammability-reducing gas is not being supplied and liquid fuel enters into the distribution conduit 20, through aircraft maneuvering, for example, and the liquid is not drained back through the outlet 22 through which it entered, the fuel will become temporarily trapped in the conduit 20 and, if it passes the gooseneck 32, will flow to the trap 26. But the trapped fuel will flow later through the float drain valve 30 and drain back into the fuel tank 12 once the fuel level recedes, thus preventing fuel column build-up against the check valve 24.

The illustrated aircraft also includes a fuel tank venting system 10 that includes a venting conduit or pipe 40 to vent the fuel tanks 12 to the left and right surge tanks 16 to accommodate pressure changes as the aircraft ascends or descends or experiences different pressures on each end of the venting conduit 40. The venting conduit 40 typically is positioned relatively high in the fuel tanks 12 and includes a main conduit 42 that extends between the surge tanks 16 and branch conduits 44 that extend from the main conduit 42 to inlet openings 46 in the fuel tank 12.

The amount of flammability-reducing gas that must be sent to the fuel tank 12 to maintain non-flammable conditions varies greatly during a flight. During an ascending phase of the flight, for example, the ambient pressure decreases as altitude increases. As a result, ullage gas in the fuel tank vents overboard to maintain pressure equilibrium between the tank 12 and the surge tank 16. During the climbing phase of the flight, the amount of flammability-reducing gas required to maintain a non-flammable condition within the fuel tank is relatively low.

Likewise, during a cruise phase of the flight, altitude is held relatively constant and the amount of flammability-reducing gas required to maintain an inert condition is relatively low, but some flammability-reducing gas typically is added to maintain a non-flammable condition as ullage volume expands due to fuel depletion and pressure changes due to incremental altitude changes. As an aircraft descends, the ambient pressure increases as the altitude decreases. Consequently, there is typically a large inrush of outside air into the ullage space during the descent regime. The inrush of atmospheric air can quickly raise the oxygen concentration in the ullage, which may exceed the limiting oxygen concentration for inertness, increasing tank flammability exposure. Therefore, as an aircraft descends in altitude, a larger amount of flammability-reducing gas is distributed to the ullage space in the fuel tanks 12. Consequently, the flammability-reducing gas supply 14 is controlled to deliver varying quantities of gas, or no gas, depending in part on the attitude of the aircraft during flight.

In summary, a flammability-reducing gas distribution system 10 for an aircraft includes a conduit 20 for distributing flammability-reducing gas within the fuel tank 12 while preventing or minimizing the potential for the buildup of a column of liquid against a check valve 24 that prevents the exit of liquid fuel from the fuel tank 12. The conduit 20 includes a trap 26 in which liquid that enters the conduit 20 and passes the gooseneck 32 can accumulate. The trap 26 includes a drain 30, such as a float drain valve, to drain liquid from the trap 26 back into the fuel tank 12. The trap 26 includes a section of the conduit 20 at a local minimum elevation between sections of conduit 20 with relatively higher elevations. Consequently, any liquid that enters the distribution conduit 20 can be captured and drained through the trap 26, minimizing or eliminating the opportunity for a large liquid column to form against the check valve 24.

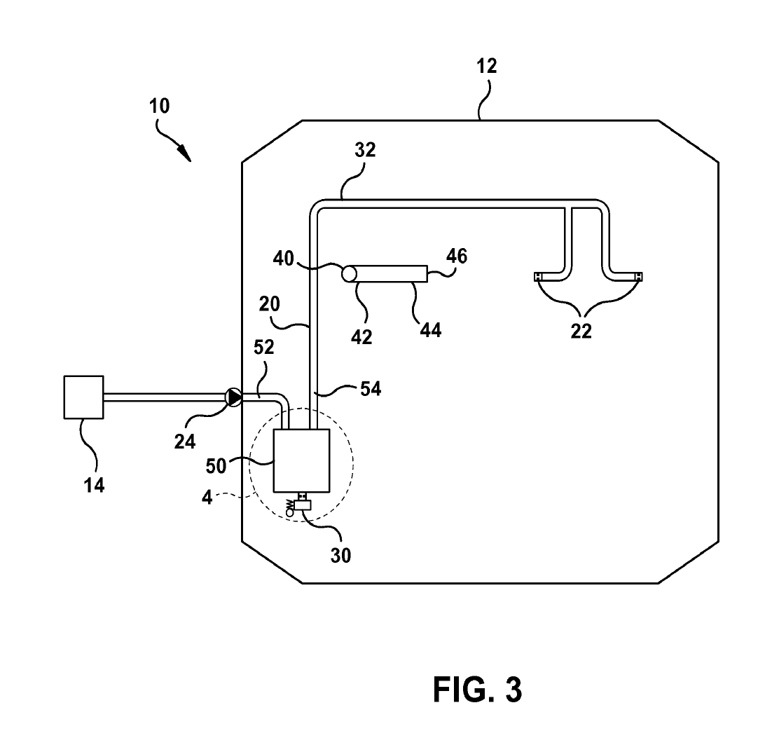

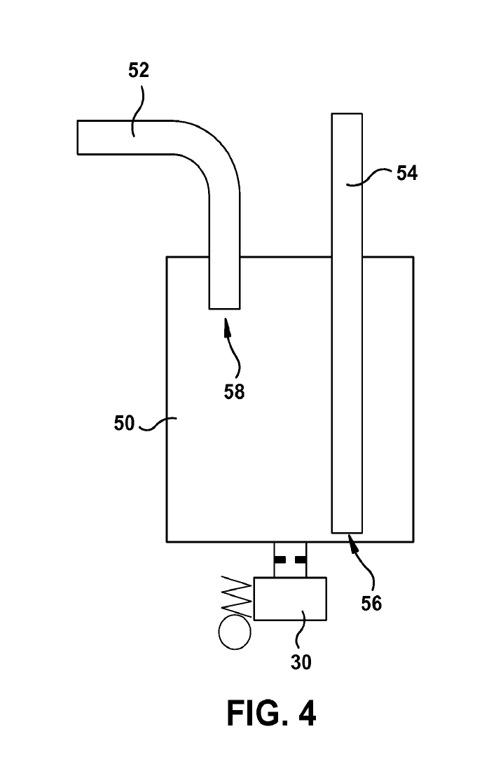

Another exemplary embodiment of the invention is shown in FIGS. 3 and 4. The system shown in these figures is substantially the same as that shown in FIG. 2, however, in place of a simple J-shape trap 26, which generally is formed of substantially constant diameter conduit at a local minimum in the distribution network, the embodiment shown in FIGS. 3 and 4 has a reservoir trap 50 at a local minimum elevation within the tank 12. The reservoir 50 is formed by an enlarged chamber coupled between sections of conduit 20. The reservoir 50 behaves in substantially the same manner as the J-shape trap 26 in the preceding embodiment, but can capture a much larger volume of liquid.

Unlike the conduit in the trap 26 shown in FIG. 1, the conduit through the reservoir 50 is discontinuous, as shown in FIG. 4. In this embodiment, the trap is the reservoir 50 coupled to sections of conduit that extend above the reservoir 50. These sections of conduit include a supply-side conduit 52 coupled to the supply 14 of flammability-reducing gas, and an outlet-side conduit 54 coupled to the fuel tank 12 via the distribution outlets 22. The downstream, outlet-side conduit 54 extends into the reservoir 50 to a location relatively near the bottom of the reservoir 50. The reservoir 50 in this embodiment is coupled to a drain 30, such as the float drain valve described above. Alternatively, a pump may be provided to remove liquid from the reservoir and move it back to the fuel tank. As another alternative, however, the reservoir 50 is provided with neither a drain nor a pump. When enough fuel or other liquid has entered the reservoir 50 to a level above the opening 56 to the outlet-side conduit 54, pressure generated by flammability-reducing gas entering the reservoir 50 from the supply-side conduit 52 forces the liquid in the reservoir 50 back up the outlet-side conduit 54 and out the distribution outlets 22 in the conduit, back into the fuel tank 12.

The supply-side conduit 52 has a discharge outlet 58 near an upper surface of the reservoir 50. Consequently, any liquid that enters the reservoir 50 through the outlet-side conduit 54 must fill the volume of the reservoir 50, before the liquid may enter the supply side conduit 52. Placing the supply-side conduit outlet 58 near an upper side of the reservoir 50 therefore minimizes the opportunity for liquid to accumulate and apply pressure against the check valve 24.

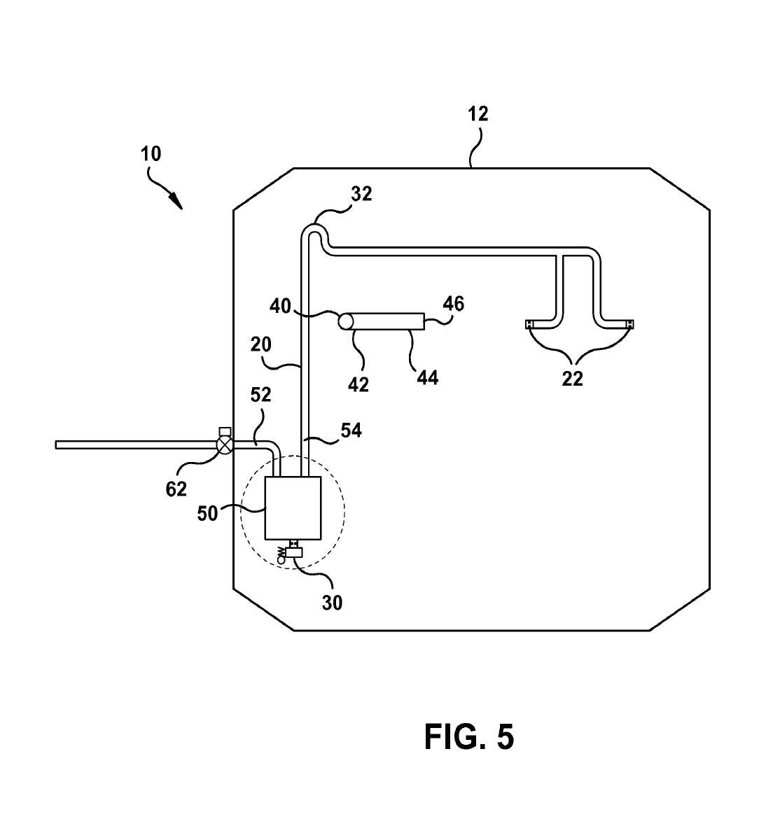

By placing the opening 56 to the outlet-side conduit 54 near the bottom or lowest elevation point in the reservoir 50 and the supply-side conduit 52 at an elevation relatively high in the reservoir 50, when the outlet-side conduit 54 is submerged in liquid, pressure from the flammability-reducing gas entering the supply-side conduit 52 will tend to push the liquid back up the outlet-side conduit 54. In some situations, this is sufficient to drain the reservoir 50. The illustrated embodiment also includes a float drain valve 30, however, to provide secondary means to drain liquid from the reservoir 50, particularly in the event that the pressure generated by the flammability-reducing gas is insufficient to force the liquid out through the distribution outlets 22 via the outlet-side conduit 54. Also note in FIG. 3 that the outlet-side conduit 54 extends to a relatively high point in the fuel tank 12 but does not include a goose-neck extension at the high point 32, as shown in FIG. 5.

The embodiment shown in FIG. 5 includes the reservoir 50 of FIGS. 3 and 4 while also including a goose-neck extension of the conduit at a local high point 32 in the outlet-side conduit 54 coming from the reservoir 50, and between the reservoir 50 and the distribution outlets 22. The embodiment shown in FIG. 5 also includes an isolation valve 62 that can be actively or passively controlled, such as an actuator-controlled ball valve, the present invention not being limited to the use of a check valve 24 as shown in FIGS. 1-3.

As should be clear from the foregoing description, the present invention provides one or more of the features set forth in the following clauses:

A. A flammability-reducing gas distribution system 10 for an aircraft, the aircraft having a supply 14 of flammability-reducing gas and a fuel tank 12, the system 10 comprising: a conduit 20 for delivering flammability-reducing gas from the flammability-reducing gas supply 14 to the fuel tank 12, the conduit 50 including (a) a distribution outlet 22 that opens into the fuel tank 12 to supply flammability-reducing gas to the fuel tank 12, (b) a valve 24 separating the flammability-reducing gas supply 14 and the distribution outlet 22 to prevent backflow of fluid to the flammability-reducing gas supply 14, and (c) a trap 26 for accumulating liquid that may enter through the distribution outlet 22.

B. A flammability-reducing gas distribution system as set forth in clause A or any other clause depending from clause A, where the trap 26 includes a J-shape section of conduit that extends below the separating valve 24.

C. A flammability-reducing gas distribution system as set forth in clause A or any other clause depending from clause A, where the trap includes a reservoir 50.

D. A flammability-reducing gas distribution system 10 as set forth in clause A or any other clause depending from clause A, where the trap 26 includes a drain 30 at a point below the separating valve 24.

E. A flammability-reducing gas distribution system 10 as set forth in clause D or any other clause depending from clause D, where the drain 30 is connected to the trap 26 at an elevation below the distribution outlet 22.

F. A flammability-reducing gas distribution system 10 as set forth in clause D or any other clause depending from clause D, where the drain 30 includes a float drain valve.

G. A flammability-reducing gas distribution system 10 as set forth in clause A or any other clause depending from clause A, where the conduit 20 includes a local high point 32 between the trap 26 and the outlet 22.

H. A flammability-reducing gas distribution system 10 as set forth in clause A or any other clause depending from clause A, where the conduit 20 includes a local high point 32 between the valve 24 and the trap 26.

I. A flammability-reducing gas distribution system 10 as set forth in clause A or any other clause depending from clause A, where the conduit 20 includes multiple distribution outlets 22.

J. A flammability-reducing gas distribution system 10 as set forth in clause A or any other clause depending from clause A, where the conduit 20 includes one or more orifices between the trap 26 and the distribution outlets 22.

K. A flammability-reducing gas distribution system 10 as set forth in clause D or any other clause depending from clause D, where the conduit 20 includes an orifice between the trap 26 and the drain 30.

L. A flammability-reducing gas distribution system 10 as set forth in clause A or any other clause depending from clause A, where the conduit 20 defines a passage for the flow of flammability-reducing gas from the valve 24, through the trap 26, out the distribution outlet 22 and into the fuel tank 12.

M. A flammability-reducing gas distribution system 10 as set forth in clause A or any other clause depending from clause A, where the separating valve 24 is outside the fuel tank 12.

N. A flammability-reducing gas distribution system 10 as set forth in clause A or any other clause depending from clause A, where the separating valve 24 is a check valve designed to allow flow in only one direction.

O. A flammability-reducing gas distribution system 10 as set forth in clause A or any other clause depending from clause A, where the separating valve 24 is a passively controlled isolation device.

P. A flammability-reducing gas distribution system 10 as set forth in clause A or any other clause depending from clause A, where the separating valve 24 is an actively controlled isolation device.

Q. A flammability-reducing gas distribution system 10 as set forth in clause A or any other clause depending from clause A, where the trap 26 is inside the fuel tank 12.

R. A flammability-reducing gas distribution system 10 as set forth in clause A or any other clause depending from clause A, where the separating valve 24 is outside the fuel tank.

S. A flammability-reducing gas distribution system 10 for an aircraft having a supply of flammability-reducing gas 14 and a fuel tank 12, comprising:

means 20 for delivering flammability-reducing gas from the flammability-reducing gas supply 14 to the fuel tank 12, the delivering means 20 including (a) a distribution outlet 22 that opens into the fuel tank 12 to supply flammability-reducing gas to the fuel tank 12, (b) means 24 for separating the flammability-reducing gas supply 14 and the distribution outlet 22 to prevent backflow of fluid to the flammability-reducing gas supply 14, and (c) means 26 for accumulating liquid that may enter through the distribution outlet 22.

T. A flammability-reducing gas distribution system 10 as set forth in clause S or any other clause depending from clause S, where the delivering means includes a conduit 20, the preventing means includes a check valve 24, and the accumulating means 26 including a section of the conduit at a local minimum elevation between sections of the conduit with a relatively higher elevation.

Although the invention has been shown and described with respect to a certain preferred embodiment, equivalent alterations and modifications will occur to others skilled in the art upon reading and understanding this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention.

1. A flammability-reducing gas distribution system for an aircraft, the aircraft having a supply of flammability-reducing gas and a fuel tank, the system comprising:
a conduit for delivering flammability-reducing gas from the flammability-reducing gas supply to the fuel tank, the conduit including (a) a distribution outlet that opens into the fuel tank to supply flammability-reducing gas to the fuel tank, (b) a valve separating the flammability-reducing gas supply and the distribution outlet to prevent backflow of fluid to the flammability-reducing gas supply, and a trap for accumulating liquid that may enter through the distribution outlet.

2. A flammability-reducing gas distribution system as set forth in claim 1, where the trap includes a J-shape section of conduit that extends below the separating valve.

3. A flammability-reducing gas distribution system as set forth in claim 1, where the trap includes a reservoir.

4. A flammability-reducing gas distribution system as set forth in claim 1, where the trap includes a drain at a point below the separating valve.

5. A flammability-reducing gas distribution system as set forth in claim 4, where drain is connected to the trap at an elevation below the distribution outlet.

6. A flammability-reducing gas distribution system as set forth in claim 4, where the drain includes a float drain valve.

7. A flammability-reducing gas distribution system as set forth in claim 1, where the conduit includes a local high point between the trap and the distribution outlet.

8. A flammability-reducing gas distribution system as set forth in claim 1, where the conduit includes a local high point between the separating valve and the trap.

9. A flammability-reducing gas distribution system as set forth in claim 1, where the conduit includes multiple distribution outlets.

10. A flammability-reducing gas distribution system as set forth in claim 1, where the conduit includes one or more orifices between the trap and the distribution outlet.

11. A flammability-reducing gas distribution system as set forth in claim 4, where the system includes an orifice between the trap and the drain.

12. A flammability-reducing gas distribution system as set forth in claim 1, where the conduit defines a passage for the flow of flammability-reducing gas from the separating valve, through the trap, out the distribution outlet, and into the fuel tank.

13. A flammability-reducing gas distribution system as set forth in claim 1, where the separating valve is outside the fuel tank.

14. A flammability-reducing gas distribution system as set forth in claim 1, where the separating valve is a check valve designed to allow flow in only one direction.

15. A flammability-reducing gas distribution system as set forth in claim 1, where the separating valve is a passively controlled isolation device.

16. A flammability-reducing gas distribution system as set forth in claim 1, where the separating valve is an actively controlled isolation device.

17. A flammability-reducing gas distribution system as set forth in claim 1, where the trap is inside the fuel tank.

18. A flammability-reducing gas distribution system as set forth in claim 1, where the separating valve is outside the fuel tank.

19. A flammability-reducing gas distribution system for an aircraft having a supply of flammability-reducing gas and a fuel tank, comprising:
means for delivering flammability-reducing gas from the flammability-reducing gas supply to the fuel tank, the delivering means including (a) a distribution outlet that opens into the fuel tank to supply flammability-reducing gas to the fuel tank, (b) means for separating the flammability-reducing gas supply and the distribution outlet to prevent backflow of fluid to the flammability-reducing gas supply, and (c) means for accumulating liquid that may enter through the distribution outlet.

20. A flammability-reducing gas distribution system as set forth in claim 19, where the delivering means includes a conduit, the preventing means includes a check valve, and the accumulating means including a section of the conduit at a local minimum elevation between sections of the conduit with a relatively higher elevation.
